(19) United States
(12) Patent Application Publication
(10) Pub. No.: US 2007/0119345 A1
(43) Pub. Date: May 31, 2007

(54) Process for the preparation of organic materials

(75) Inventor: Bansi Lal Kaul, Biel-Benken (CH)

Correspondence Address: Norris, McLaughlin & Marcus P.A., 18th Floor, 875 Third Avenue, New York, NY, 10022, US

(73) Assignee: MCA Technologies, GmbH, Biel-Benken (CH)

(21) Appl. No.: 11/521,194

(22) Filed: Sep. 13, 2006

Related U.S. Application Data
(63) Continuation-in-part of application No. PCT/IB04/00530, filed on Feb. 20, 2004.

(51) Int. Cl. C08K 5/00

(52) U.S. Cl. 106/493; 106/494; 106/495; 106/496; 106/497; 106/498

(57) ABSTRACT

The present invention relates to advantageous processes for the manufacture of organic pigments and their precursors. The invention particularly relates to reactions carried out in an “All In One Reactor”® (Draiswerke GmbH, Germany), a kneader like the TurbuKneader® of the same company, a paddle dryer like the Turbudry® of the same company or a related system and thereby submitting the reaction mixtures to enhanced driving power as expressed by a Froude number >1, the reaction mixture being caused to react in high concentrations at elevated temperature.

This is a continuation in part application filed under 35 USC 111(a) of WO 2005/085364 A1.

The present invention relates to an advantageous process for the preparation of quinacridone pigments, isoindolinone pigments, isoindoline pigments, quinophthalone pigments, and the precursors thereof, to the products obtained by such process and to their use.

The present invention particularly provides a process for preparing the said pigments and their corresponding precursors in a special reactor enabling use of much lesser quantities of solvents and reagents in the synthesis, and particularly the lesser amount of dehydrating agent in the cyclisation process of quinacridone pigments than used in standard batch methods. Use of such smaller quantities of solvents and reagents, particularly the dehydrating agents in the quinacridone cyclisation process, produce high viscosities and are technically unmanageable in state-of-the-art reactors. Use of smaller quantities of solvents and dehydrating agent according to the present invention not only ensures better economy but also better ecology in manufacturing.

### BACKGROUND OF THE INVENTION

Quinacridone pigments are one of the most important groups of high-performance organic pigments used universally for almost all applications of organic pigments. Processes for the preparation of quinacridone pigments are known. E.g., Edward E. Jaffe in “High Performance Pigments” page 279, Ed. by H. M. Smith, Wiley-VCH Verlag-GmbH, Weinheim Germany, 2002; S. S. Labana and L. L. Labana, “Quinacridones” in Chemical Review, 67, 1-18 (1967), and U.S. Pat. Nos. 3,157,659; 3,256,285; and 3,317,539.

The preferred method of synthesis for the formation of quinacridone pigments involves the formation of a dialkyl succinnoylsuccinate of formula II, wherein R₁ represents an alkyl group, from the corresponding dialkyl succinate of formula I either separately (U.S. Pat. Nos. 3,024,268 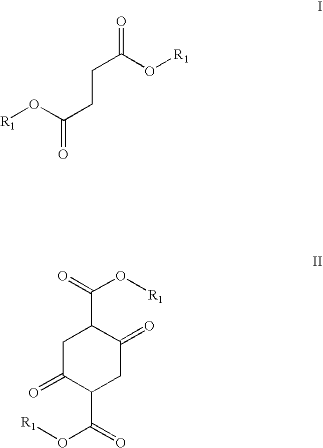
and 3,045,040) or in situ in the presence of a base in a high boiling inert solvent (U.S. Pat. Nos. 2,821541 and 3,156,719).

The resulting dialkyl succinoylsuccinate of formula II is in turn reacted with aryl amines, again either separately or in situ, to yield 2,5-di(arylamino)-3,6-dihydroterephthalic acid dialkyl esters of formula III followed by their cyclisation to 6,13-dihydroquinacridones of formula IV and ultimately to the quinacridone pigments of formula VI by oxidation (e.g. U.S. Pat. Nos. 5,659,036; 5,817,817).

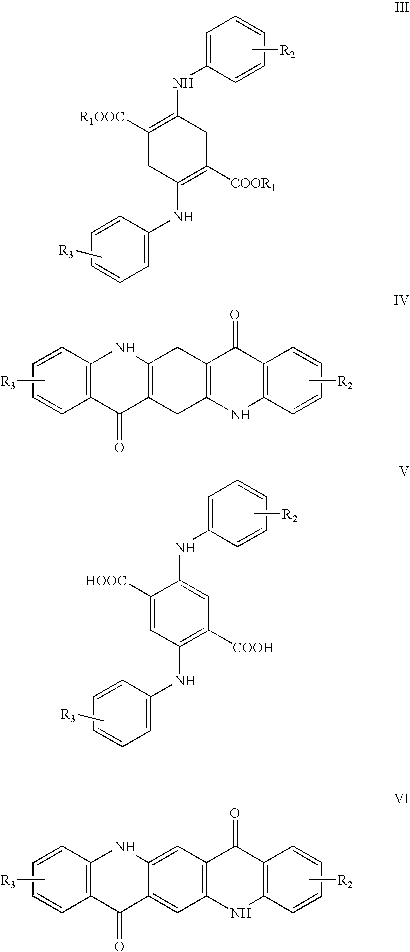

An alternative preferred method for preparing quinacridones involves oxidation or oxidation and hydrolysis of 2,5-di(arylamino)-3,6-dihydroterephthalic acid dialkyl esters of the formula III to the corresponding 2,5-di(arylamino)-terephthalic acid dialkyl esters of the formula VII or 2,5-diarylaminoterephthalic acids of the formula V (e.g. U.S. Pat. Nos. 3,031,501; 4,124,768).

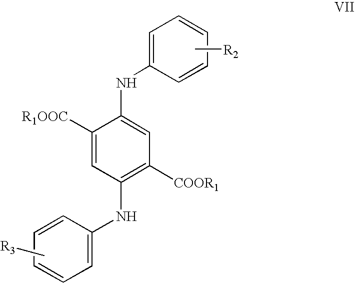

The resulting 2,5-diarylaminoterephthalic acid intermediates of formulae V and VII are then subjected to thermally induced ring closure in the presence of polyphosphoric acid (e.g., U.S. Pat. Nos. 3,257,405; 5,591,258; 6,241,814) or even sulphuric acid (e.g., U.S. Pat. No. 3,200,122 and European Patent Application 863,186). After the ring closure is complete, pouring into a liquid in which the quinacridone is substantially insoluble, usually water and/or an alcohol drowns the melt. To be able to pour out, the reaction needs to be carried out in large quantities of the dehydrating agent, making the process uneconomical and environmentally unfriendly.

The resultant crystalline pigment is then further conditioned by solvent treatment or milling in combination with solvent treatment.

Final particle size of quinacridone pigments can be controlled by the methods used in both synthesis and aftertreatment. For example, quinacridone pigments can be made more transparent by reducing the particle size or more opaque by increasing the particle size. In known methods, particle size is generally controlled during precipitation of the pigment by drowning or during milling or solvent treatment of the crude pigment. Tinctorial strength and transparency of pigments can also be affected by solvent treatment. Aftertreatment steps that manipulate the crude pigments particle size is often referred to as conditioning methods.

Although batch wise processes can produce good quality product, more efficient continuous processes have also been reported for thermally induced ring closure in the presence of polyphosphoric acid for the preparation of quinacridones (see U.S. Pat. No. 6,068,695 ; WO 02/38680). However, because of the limited dwelling time for the reaction in the continuous process, such processes cannot provide the quality of the products obtained by batch processes without affecting the productivity. Moreover, such continuous processes requiring lesser amounts of reagents have been described only for the ring closure step and not for the preparation of the precursors.

### DESCRIPTION OF THE INVENTION

An objective of the present invention is to manufacture organic pigments and their precursors, while avoiding the disadvantages of the cumbersome processes of the prior art such as excessive use of solvents, reagents and even multistep processes.

The present invention therefore provides a process for preparing quinacridone pigments and their precursors inherently bearing the advantages of both batch method, such as quality; and continuous process such as efficiency and better ecology by using smaller amounts of solvents and/or dehydrating agent than used in standard methods, even when such smaller quantities of the solvents and dehydrating agents produce high viscosities. In addition to allowing the use of smaller quantities of solvents and dehydrating agent, which lowers manufacturing costs and reduces environmental impact, the present invention produces quinacridones having characteristics of batch processes.

This objective is attained by a process for the manufacture of quinacridone pigments and/or their precursors in an apparatus by submitting the highly concentrated and viscous reaction mixture to enhanced driving power as expressed by a Froude number >1. The mixture is caused to react at a suitable elevated temperature, with or without vacuum, optionally at the same time removing during and/or at the end of the reaction any volatile by-products formed and smaller amounts of solvents if and when used in the process.

The Froude number Fr is defined by the formula

$$Fr = \frac{{v}^{2}}{r \cdot g}$$

in which v is the velocity of the operative part, r is the radius of the operative part and g is the gravity of the treated materials. Such effect is obtained at overcritical speed >100 r/min and can be achieved independently of the apparatus size. Examples of such apparatus are e.g. “All In One Reactor”® (Draiswerke GmbH, Germany), a kneader like the TurbuKneader® of the same company, a paddle dryer like the Turbudry® of the same company or a related system.

According to one particular aspect of the present invention, there is provided a process for the production of dialkyl succinnoylsuccinate of the formula II by the self-condensation of dialkyl succinate of the formula I in the presence of alkali-metal alkylates, without the use of any solvent. The alkali-metal alkylates can be used either as solids, or solutions or dispersions. The alkyl rest of the dialkyl succinate and alkali-metal alkylates used in the present invention is a lower alkyl group having 1 to 4 carbon atoms or a substituted alkyl group having 1 to 4 carbon atoms. Specific examples of the alkyl include methyl, ethyl, isopropyl, n-butyl, iso-butyl, sec-butyl and tert-butyl. Further embodiment of the process is that the alkyl groups of the dialkyl succinate and alkali-metal alkylates need to be identical. The reaction is carried out in an oxygen-free atmosphere at a reaction temperature between 70° C. and 130° C., thereby simultaneously removing the alcohol formed in the reaction, as well as the dispersing liquid medium if and when used.

Further, according to another aspect of the present invention, there is provided a process for the production of 2,5-di(arylamino)-3,6-dihydroterephthalic acid dialkyl esters of the formula III, wherein R₁ is an alkyl group, by a condensation reaction between dialkyl succinoylsuccinate of the formula II and aromatic amino compounds of the formula VIIIa and/or formula VIIIb 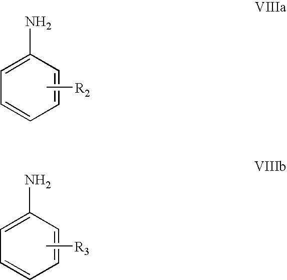
wherein R₂ and R₃ independent of each other are from 0 to 4 substituents selected from the group of F, Cl, Br, I, OH, NO₂, CF₃, an alkyl group having 1 to 4 carbon atoms, a substituted alkyl group having 1 to 4 carbon atoms, an alkoxy group having 1 to 4 carbon atoms, a substituted alkoxy group having 1 to 4 carbon atoms, a phenyl group, a cyclohexyl group, a phenoxy group, COOH, a COOC₁ to C₄ alkyl group, SO₃H, , N(CH₃)₂, an N-alkylsulfonamido group such as piperidinomethyl, dimethylaminoethyl, diethylaminoethyl, dimethylaminopropyl, diethylaminopropyl, dibutylaminopropyl, piperidinoethyl, pipecolinoethyl, morpholinoethyl, piperidinopropyl, pipecolinopropyl, diethylaminohexyl, diethylaminobutyl, dimethylaminoamyl, N,N-diethylaminoethyl-N′-laurylamine, 2-ethylhexylaminoethyl, stearylaminoethyl and oleylaminoethyl, a pyridino group, CONH₂ or CON(CH₃)₂,
the amount of the aromatic amino compound of the formula VIIIa and/or formula VIIb being 2.0 to 2.5 mol per mole of the dialkyl succinoylsuccinate of the formula II. The said polycondensation reaction is carried out in the presence, as a catalyst, of an acid such as aromatic sulfonic acids e.g. p-toluenesulfonic acid, hydrochloric acid, sulphuric acid or phosphoric acid in an amount of 0.01 to 0.5 mol per mole of the dialkyl succinoylsuccinate of the formula II. The smaller the amount of water contained in the catalyst, is, the better, since the main reaction proceeds in a dehydration-condensation reaction. The reaction is optionally carried out in the presence, as a dispersing aid, which can be easily removed at the end of the reaction, of an alcohol having 1 to 8 carbon atoms or a glycolmono C₁ to C₄ alkylether or an aliphatic or an aromatic liquid medium such as tetrachloroethane, xylenes, toluene, chlorobenzene, ortho-dichlorobenzene and N-methylpyrrolidone. The reaction is carried out in an oxygen-free atmosphere at a reaction temperature between 80° and 140° C., thereby simultaneously and/or subsequently removing the water formed in the reaction along with the dispersing liquid medium. The preferred liquid mediums are those that can form azeotropes with the water formed in the reaction.

According to a further aspect of the present invention, there is provided a process for producing dihydroquinacridone IV, which comprises mixing the 2,5-di(arylamino)-3,6-dihydroterephthalic acid dialkyl ester III, obtained according to the above process of the present invention for example, with a heating medium commercially available in the trade name of “Dowtherm A” which is a mixture of biphenyl and biphenyl ether, or with any one of alkylnapthalene, N-methylpyrrolidone, dibenzyl ether and t-amyl alcohol, and heating the mixture up to 200° to 350° C. under atmospheric pressure or elevated pressure, whereby the alkyl group and aryl amino group of the ester portion of the 2,5-di(arylamino)-3,6-dihydroterephthalic acid dialkyl ester undergo intramolecular alcohol-elimination and the 2,5-di(arylamino)-3,6-dihydroterephthalic acid dialkyl ester is converted to a corresponding 6,13-dihydroquinacridone which is substituted as required.

The corresponding 6,13-dihydroquinacridone substituted as required is preferably obtained by adding dimethylnaphthalene isomer mixture of which the weight is at the most 2.5 times as large as that of the 2,5-di(arylamino)-3,6-dihydroterephthalic acid dialkyl ester to the above 2,5-di(arylamino)-3,6-dihydroterephthalic acid dialkyl ester and heating the mixture to 200° to 350° C., either under atmospheric pressure or under elevated pressure up to 10 bar in an oxygen-free atmosphere. The alcohol formed is preferably allowed to distil off during the process.

The 6,13-dihydroquinacridones of the formula IV obtained by the above process of the present invention can be converted to a corresponding quinacridone, for example, by oxidizing the 6,13-dihydroquinacridone with an oxidizing agent such as sodium m-nitrobenzenesulfonate, nitrobenzene, nitronaphthalene, nitrobenzenesulfonic acid, nitrobenzenecarboxylic acid, nitrophenol, oxygen or air, in the presence of a mixed solvent of methanol, ethanol, acetone, ethylene glycol or glycol ether with water, in the presence of an alkali, at a high temperature, optionally under elevated pressure, and optionally in the presence of a dispersing agent and a reaction promoter. The oxidation is carried out, for example, with air in the presence of a dispersing agent, preferably an anionic dispersing agent such as a condensate from aromatic sulfonic acid and formaldehyde.

The 2,5-di(arylamino)-3,6-dihydroterephthalic acid dialkyl ester III produced according to the present invention can be converted to a corresponding 2,5-di(arylamino)terephthalic acid V by treating it in a mixed solvent of a solvent with water in the presence of an oxidizing agent and an alkali, at a high temperature, optionally under elevated pressure and optionally in the presence of a dispersing agent and a reaction promoter. The above oxidizing agent includes sodium m-nitrobenzenesulfonate, nitrobenzene, nitronaphthalene, nitrobenzenesulfonic acid and nitrophenol. The above solvent includes methanol, ethanol, acetone, ethylene glycol and glycol ether.

Further, the 2,5-di(arylamino)terephthalic acid V obtained by the above process of the present invention can be converted to a corresponding quinacridone by heating the 2,5-di(arylamino)terephthalic acid up to 100° to 180° C. while mixing it with polyphosphoric acid or polyphosphoric acid of which the weight is 2-3 times as large at the most as that of the 2,5-di(arylamino)terephthalic acid. In this process, the 2,5-di(arylamino)terephthalic acid undergoes an intramolecular-dehydration, ring-closing reaction to be converted to a corresponding quinacridone. Or, the 2,5-di(arylamino)terephthalic acid can be converted to a corresponding quinacridone by a method in which the 2,5-di(arylamino)terephthalic acid V is mixed with a ring-closing agent and an acid catalyst or an organic catalyst in an organic solvent slightly miscible with water and the mixture is heated up to 150° to 210° C., whereby the 2,5-di(arylamino)terephthalic acid undergoes an intramolecular-dehydration, ring-closing reaction to be converted to a corresponding quinacridone. The above ring-closing agent includes nitrobenzene, nitronaphthalene, aniline, phosgene, benzoyl chloride and ethylene glycol. The above acid catalyst includes hydrochloric acid and acetic acid. The above organic catalyst includes quinoline.

The following quinacridones can particularly be synthesized according to the present invention.

quinacridone, 2,9-dichloroquinacridone, 3,10-dichloroquinacridone,

4,11 -dichloroquinacridone, 2,3,9,10-tetrachloroquinacridone, 2,4,9,11-tetrachloroquinacridone, 2,9-difluoroquinacridone, 2,9-dibromoquinacridone, 2,9-dimethylquinacridone, 3,10-dimethylquinacridone, 4,11-dimethylquinacridone, 2,4,9,11-tetramethylquinacridone, 2,9-di(tert-butyl)quinacridone, 2,9-dihydroxylquinacridone, 2,9-di(trifluoromethyl)quinacridone, 2,9-dimethoxyquinacridone, 2,9-diethoxyquinacridone, 2,4,9,11-tetramethoxyquinacridone, 2,9-dicarboxylquinacridone, 2,9-dichlorohexylquinacridone, 2,9-diphenylquinacridone, 2,9-di(dimethylamino)quinacridone, 2,9-di(dimethylaminosulfo)quinacridone, 2,9-di(dimethylaminocarbonyl)quinacridone, 3,10-dinitroquinacridone, 2,9-dimethyl-4,11-dichloroquinacridone, 2,9-dimethyl-4,11-dicarboxyquinacridone, and 2,9-dipyridinoquinacridone.

It is also possible to use mixtures of the arylamines VIIIa and VIlIb or the mixtures of 2,5-diarylamino-3,6-dihydroterephthalic acid dialkyl esters III or 2,5-diarylaminoterephthalic acids V in this process. The use of such mixtures provides a particularly advantageous method for obtaining quinacridone solid solutions. Mixtures containing 2,5-diarylaminoterephthalic acid or 2,5-diarylamino-6,13-dihydroterephthalic acid or a derivative thereof in combination with a fully formed quinacridone pigment (generally in crude form) can also be used.

A critical feature of the invention is the inclusion of small quantities of the N-alkylsulfonamido substituted 2,5-diarylamino-3,6-dihydroterephthalic acid dialkyl esters III or 2,5-diarylaminoterephthalic acids V during the ring-closure reaction used to prepare the quinacridone pigment composition. Such pigment compositions exhibit even better pigmentary properties.

Optionally, the small amounts of N-alkylsulfonamido substituted 6,13-dihydroquinacidones or N-alkylsulfonamido substituted quinacidones can be incorporated following the cyclisation process. The amount of such additives may not exceed 5 parts of the final pigment composition in order not to impair its properties.

According to the present invention, there is also provided a process for the production of the isoindolinone compounds of formula IX. E.g., Abul Iqbal et.al. in “High Performance Pigments” page 231, Ed. by H. M. Smith, Wiley-VCH Verlag-GmbH, Weinheim Germany, 2002. 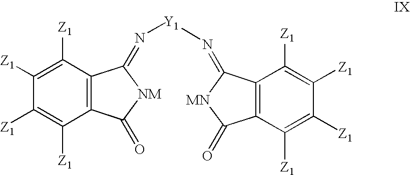
wherein M is a hydrogen or an alkali metal, preferably sodium or potassium, Z₁ halogen or hydrogen, and Y₁ is an aromatic residue of the formula

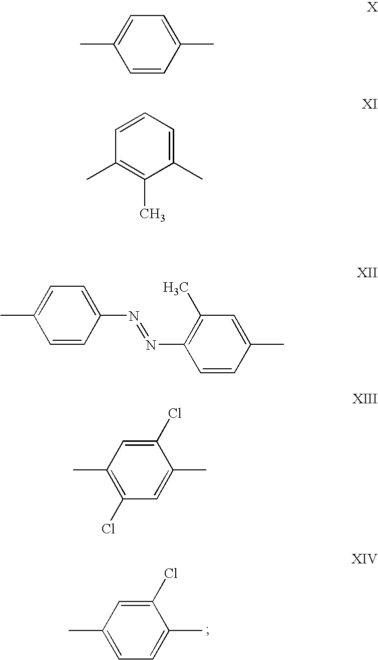

The starting materials used are preferably the isoindolinones of the formula XV produced in situ or separately from the corresponding ester of tetrachloro-o-cyanobenzoic acid of the formula XVI, and the diamines of the formula —H₂N—Y₁—NH₂, 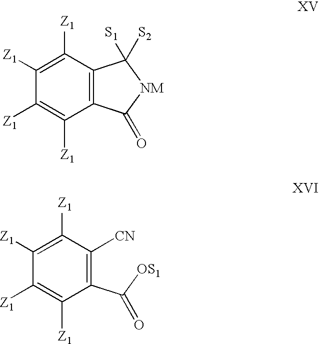
wherein Z₁ has the indicated meaning and S₁ and S₂ denote alkoxy groups. The corresponding ester of tetrachloro-o-cyanobenzoic acid are obtained by the process of DOS 2,301,863.

The following may be mentioned as examples of the isoindolinones of the formula XV:

3,3-dimethoxy-4,5,6,7-tetrachloro-isoindolin-1-one, 3,3-dimethoxy-4,5,6,7-tetrabromo-isoindolin-1-one,

The diamines H₂N—Y₁—NH₂ used are preferably:

p-phenylenediamine, 2-chloro-p-phenylenediamine and 2,6-diaminotoluene.

If alkali metal salts of the 3,3-dialkoxy-4,5,6,7-tetrachloroisoindolin-1-ones XV are used as starting materials, water-miscible organic solvents, for example lower aliphatic alcohols, such as lower alkanols, for example methanol, isopropanol or butanol, lower cyclic ethers, such as dioxane, ethylene glycol monomethyl ether or lower aliphatic ketones, such as acetone, are used with advantage. In these cases, the condensation takes place even at relatively low temperatures from 0 to 20° C. The reaction is advantageously carried out in the presence of agents, which bind bases; as examples of such agents there should be mentioned lower fatty acids, which then simultaneously act as solvents, and especially acetic acid.

According to this invention, there is also provided an advantageous process for the production of the isoindoline compound of the formula XVII. E.g., Volker Radtke et.al. in “High Performance Pigments” page 211, Ed. by H. M. Smith, Wiley-VCH Verlag-GmbH, Weinheim Germany, 2002 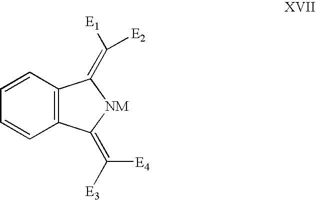
wherein E₁ through E₄ represent CN, CONH-alkyl or CONH-aryl. E₁/E₂ and E₃/E₄ can also be members of a mono- and poly-heterocyclic ring systems or combinations thereof. Examples of such compounds are the pigments and derivatives of: C.I. Pigment Yellow 139, C.I. Pigment Yellow 185, C.I. Pigment Orange 66, C.I. Pigment Orange 69, C.I. Pigment Red 260, C.I. Pigment Brown 38.

The present invention also provides an advantageous process for the production of the quinophthalone compound of the formula XVIII, wherein Y represents a hydrogen or a halogen atom. E.g., Volker Radtke in “High Performance Pigments” page 307, Ed. by H. M. Smith, Wiley-VCH Verlag-GmbH, Weinheim Germany, 2002.

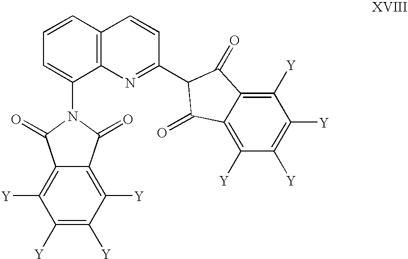

The compounds of the formula XVIII are obtained by the reaction between the 8-aminoquinaldine of formula XIX and the aryldicarboxylic anhydride of the formula XX

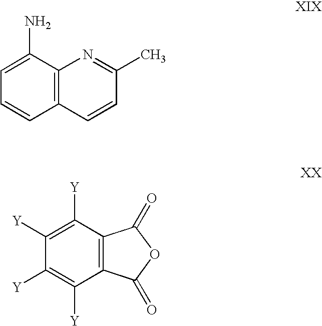

The reaction for the production of quinophthalones may be carried out in the absence of solvent. Generally, however, it is performed in the presence of a solvent. In the process of the present invention, however, the amount of solvent used is considerably less. Useful solvents are organic solvents inert under the reaction conditions, for example, hydrocarbons such as decaline, tetralin or trimethylbenzene; halogenated hydrocarbons such as dichlorobenzene, trichlorobenzene or chloronaphthalene; nitrated hydrocarbons such as nitrobenzene; ethers such as diphenyl ether; and N-methylpyrrolidone.

The reaction is carried out generally under heat. The heating temperature can be varied over a wide range according, for example, to the types and proportions of the starting materials, or the type of the solvent. Usually, it is 150° to 350° C., preferably 180° to 300° C. The reaction pressure is usually normal atmospheric pressure, but if desired, the reaction may be performed at a reduced or elevated pressure from 0.1 to 10 bar. Within the above temperature range, the reaction ends generally in 2 to 10 hours.

The pigments produced according to the present invention are either directly formed or converted into a finely divided form, for pigmenting high molecular organic material, for example cellulose ethers and cellulose esters, such as ethylcellulose, acetylcellulose and nitrocellulose, polyamides or polyurethanes or polyesters, natural resins or synthetic resins, for example aminoplasts, especially urea-formaldehyde and melamine-formaldehyde resins, alkyd resins, phenoplasts, polycarbonates, polyolefines, such as polystyrene, polyvinyl chloride, polyethylene, polypropylene, polyacrylonitrile and polyacrylic acid esters, thermoplastic or thermosetting acrylic resins, rubber, casein, silicone and silicone resins, individually or as mixtures. It is immaterial whether the high molecular compounds mentioned are in the form of plastic compositions or melts or in the form of spinning solutions, lacquers or printing inks. Depending on the end use, it proves advantageous to employ the new pigments as toners or in the form of preparations.

There now follows a series of examples that serve to illustrate the invention.

### EXAMPLE 1

2280 g of dimethyl succinnoylsuccinate [formula II, in which R₁=CH₃; 4-cyclohexanedione-2,5-di(carboxylic acid methyl ester)], 1953 g of aniline, 2000 ml of isobutanol, and 40 g p-toluenesulfonic acid were placed at 20-25° C. in a 10000 ml “All In One Reactor”® of (Drais Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C. The material was emptied into a polyethylene sack, tightly fitted to the outlet of the reactor; affording 3650 g (96.5 % of theory, based on dimethyl succinnoylsuccinate [formula II, in which R₁═CH₃; 4-cyclohexanedione-2,5- 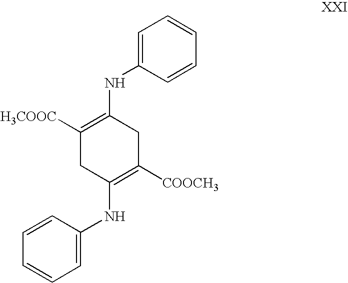
di(carboxylic acid methyl ester)] of the compound of the formula XXI Approximately 250 g of the product were still contained in the reactor to be used in the next batch. The total yield thus corresponded to approximately 3900 g (approximately 99.7% of theory, of approximately

### EXAMPLE 2

Example 1 was repeated except that the aniline was replaced with 2677.5 g of p-chloroaniline, to give 4605 g (99.3% of the theoretical yield) of 2,5-di(p-chloroanilino)-3,6-dihydroterephthalic acid dimethyl ester of formula XXII. The purity thereof was 96.3%.

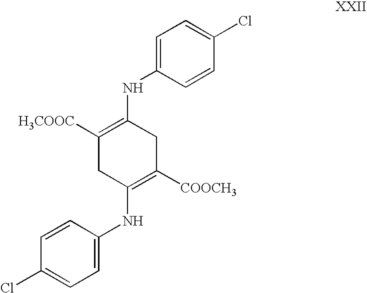

### EXAMPLE 3

Example 1 was repeated except that the aniline was replaced with 2226 g of p-toluidine, to give 4110 g (97.7% of the theoretical yield) of 2,5-di(p-toluidino)-3,6-dihydroterephthalic acid dimethyl ester of the formula XXIII. The purity thereof was 96.3%.

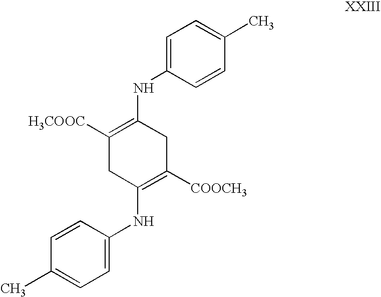

### EXAMPLE 4

1140 g of dimethyl succinnoylsuccinate (formula II, in which R1═CH₃; 4-cyclohexanedione-2,5-di(carboxylic acid methyl ester), 976.5 g of aniline, 1000 parts of isobutanol, and 25 g of phosphoric acid of 85% concentration were placed at 20-25° C. in a 10000 ml “All In One Reactor”® of (Drais Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

For the cyclisation 4000 g polyphosphoric acid (117% phosphoric acid) were now introduced into the reactor and under stirring and nitrogen flow the mixture was heated to 130° C. within 60 minutes. The temperature was maintained at 130° for 30 minutes. The reaction mass became thick and crumbly. The mixture was cooled to 70° C. Into the reactor were metered over the course of 2 hours 2000 parts of 85% strength phosphoric acid thereby allowing the temperature to rise to 150 degree C. and maintaining it thereat by external cooling during the metering in process. The resultant mass was stirred at 150° C. for one hour and emptied into an HDPE drum. The resultant material was collected by filtration and reslurried in water containing sodium hydroxide (pH greater than 10). The slurry was heated at 90 to 95.degree. C. for one hour, then collected by filtration, washed until free of alkali, and dried to give an 85% yield of dihydroquinacridone of formula XXIV (89% purity).

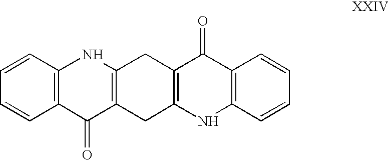

### EXAMPLE 5

1140 g of dimethyl succinnoylsuccinate (formula II, in which R1═CH₃; 4-cyclohexanedione-2,5-di(carboxylic acid methyl ester), 1113 g of p-toluidine , 1000 parts of isobutanol , and 25 g of phosphoric acid of 85% concentration were placed at 20-25° C. in a 10000 ml “All In One Reactor”® of (Drais Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

For the cyclisation 5000 g of a dimethylnaphthalene isomer mixture were now introduced into the reactor and under stirring and nitrogen flow the mixture was heated to 280° C. within 60 minutes. The temperature was maintained at 280° for 30 minutes, thereby allowing the methanol formed to distil off. The reaction mass became thick and crumbly. The mixture was cooled to 60° C. Into the reactor were metered over the course of 2 hours 2000 parts of methanol. The resultant mass was stirred at 60 degree C. for one hour and emptied into an HDPE drum. The resultant material was collected by filtration and reslurried in water containing sodium hydroxide (pH greater than 10). The slurry was heated at 90 to 95 degree C. for one hour, then collected by filtration, washed until free of alkali, and dried to give an 83% yield of dihydroquinacridone of formula XXV (91% purity).

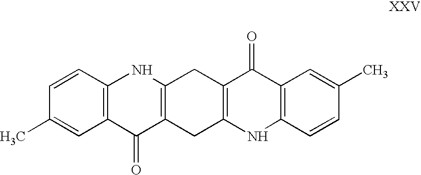

### EXAMPLE 6

4000 g polyphosphoric acid (117% phosphoric acid) and 2000 g of 2,5-dianilinoterephthalic acid (Formula V in which R₂═R₃═H) were placed at 20-25° C. in a 10000 ml “All In One Reactor”® of (Drais Mannheim Germany. Under stirring and nitrogen flow the mixture was heated to 130° C. within 60 minutes. The temperature was maintained at 130° for 30 minutes. The reaction mass became thick and crumbly. The mixture was cooled to 70° C. Into the reactor were metered over the course of 2 hours 2000 parts of 85% strength phosphoric acid thereby allowing the temperature to rise to 150 degree C. and maintaining it thereat by external cooling during the metering in process. The resultant mass was stirred at 150 degree C. for one hour and emptied into an HDPE drum. The resultant material was collected by filtration and reslurried in water containing sodium hydroxide (pH greater than 10). The slurry was heated at 90 to 95 degree C. for one hour, then collected by filtration, washed until free of alkali, and dried to give an 90% yield of the quinacridone of the formula XXVI (93% purity).

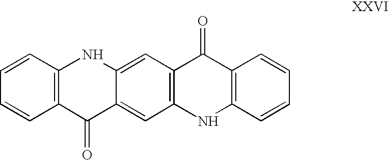

### EXAMPLE 7

5000 g of polyphosphoric acid containing 85.0% P₂ O₅ and 1250 parts of 2,5-di-(4-toluidino)terephthalic acid (Formula V wherein R₂═R₃═4-CH₃) were placed at 20-25° C. in a 10000 ml “All In One Reactor”® of (Drais Mannheim Germany). Under stirring and nitrogen flow the mixture was heated to 120° C. within 30 minutes and maintained at 120° C. for 30 minutes. Thereafter, the mixture was heated to 130° C. in 15 minutes and kept at 130° C. for one hour. The mixture was cooled to 70° C. followed by metering in of 3000 g isobutanol over a period of 2 hours with external cooling, and thereby allowing the temperature to reach the maximum reflux temperature of isobutanol. The mixture was stirred at reflux temperature for one hour, cooled to 70° C. and emptied into a Steel container. The resulting 2,9-dimethylquinacridone XXVII was collected by filtration and reslurried in water containing sodium hydroxide (pH greater than 10). The slurry was heated at 90 to 95 degree C. for one hour, then collected by filtration, washed until free of alkali, and dried to give an 85% yield of quinacridone of the formula XXVII (95% purity).

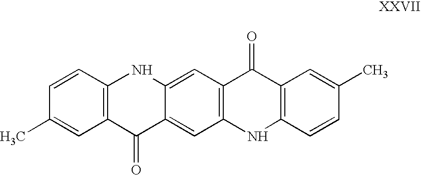

### EXAMPLE 8

2920 g dimethyl succinate (2.0 Mole) and 3600 g 30% sodium methylate solution (2.0 Mole) were placed at 20-25° C. in a 10000 ml “All In One Reactor ”® of (Drais Mannheim Germany). Under stirring and nitrogen flow the mixture was heated to 130° C. within 250 minutes. From 50° C. onwards the reaction mixture became considerably thicker and was finally converted into a paste. From approx. 80° C. onwards a rapid formation of alcohol vapours was observed. The temperature was maintained at 130° C. for three hours, thereby allowing the rest of the alcohol to distil off. The reaction mass became crumbly and finally largely disintegrated into an almost semi-powdery material. The reaction mixture was cooled to 70° C and 1860 g of aniline were added thereto followed by the addition of 2000 parts of isobutanol. Thereafter 980 g of sulphuric acid of 96% concentration and 25 g of phosphoric acid of 85% concentration were slowly added thereto with external cooling to prevent the temperature to exceed 80° C. during the addition. Under stirring and nitrogen flow the mixture was now heated to 100° C. within 60 minutes. From 80° C. onwards the reaction mixture became considerably thicker and was finally converted into a paste. The temperature was maintained at 99° to 1000° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

The material was emptied into a steel drum affording 4920 g of the product of the formula XXI of 71% purity (92.3% of theory based on 100% material). Approximately 150 g of the product were still contained in the reactor to be used in the next batch.

### EXAMPLE 9

1460 g dimethyl succinate (1.0 Mole) and 1800 g 30% sodium methylate solution (1.0 Mole) were placed at 20-25° C. in a 10000 ml “All In One Reactor”® (Drais Mannheim Germany). Under stirring and nitrogen flow the mixture was heated to 130° C. within 250 minutes. From 50° C. onwards the reaction mixture became considerably thicker and was finally converted into a paste. From approx. 80° C. onwards a rapid formation of alcohol vapours was observed. The temperature was maintained at 125° C. for three hours, thereby allowing the rest of the alcohol to distil off. The reaction mass became crumbly and finally largely disintegrated into an almost semi-powdery material. The reaction mixture was cooled to 70° C. and 1060 g of p-toluidine were added thereto followed by the addition of 2000 parts of isobutanol. Thereafter 490 g of sulphuric acid of 96% concentration and 25 g of phosphoric acid of 85% concentration were slowly added thereto with external cooling to prevent the temperature to exceed 80° C. during the addition. Under stirring and nitrogen flow the mixture was now heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

For the cyclisation 4000 g polyphosphoric acid (117% phosphoric acid) were now introduced into the reactor and under stirring and nitrogen flow the mixture was heated to 130° C. within 60 minutes. The temperature was maintained at 130° for 30 minutes. The reaction mass became thick and crumbly. The mixture was cooled to 70° C. Into the reactor were metered over the course of 2 hours 2000 parts of 85% strength phosphoric acid thereby allowing the temperature to rise to 150 degree C. and maintaining it thereat by external cooling during the metering in process. The resultant mass was stirred at 150 degree C. for one hour and emptied into an HDPE drum. The resultant material was collected by filtration and reslurried in water containing sodium hydroxide (pH greater than 10). The slurry was heated at 90 to 95.degree. C. for one hour, then collected by filtration, washed until free of alkali, and dried to give an 85% yield of 2,9-dimethyldihydroquinacridone of formula XI (89% purity).

### EXAMPLE 10

2280 g of dimethyl succinnoylsuccinate (formula II, in which R₁═CH₃; 4-cyclohexanedione-2,5-di(carboxylic acid methyl ester), 1953 g of aniline, 2000 parts of isobutanol , and 40 g p-toluenesulphonic acid were placed at 20-25° C. in a 10000 ml “All In One Reactor”® of (Drais Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 60° C. Into the reactor were now metered 3000 parts of methanol.

Then, 1350 g of sodium m-nitrobenzenesulfonate were added, and immediately thereafter, 2400 parts of a 50% NaOH aqueous solution were added. Then, the mixture was refluxed for 4 hours, acidified with sulphuric acid to PH 3 to give 3565 g (of a theoretical value ) of the compound of the formula XXVIII after emptying out filtration and washing water and drying.

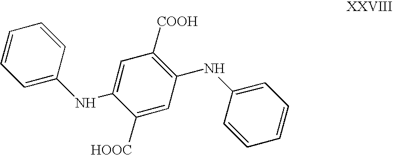

### EXAMPLE 11

1140 g of dimethyl succinnoylsuccinate (formula II, in which R₁═CH₃; 4-cyclohexanedione-2,5-di(carboxylic acid methyl ester), 1113 g of p-toluidine, 1000 parts of isobutanol, and 25 g of phosphoric acid of 85% concentration were placed at 20-25° C. in a 10000 ml “All In One Reactor”® of (Drais Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C. For the cyclisation 5000 g of a dimethylnaphthalene isomer mixture were now introduced into the reactor and under stirring and nitrogen flow the mixture was heated to 280° C. within 60 minutes. The temperature was maintained at 280° for 30 minutes, thereby allowing the methanol formed to distil off. The reaction mass became thick and crumbly. The mixture was cooled to 60° C. Into the reactor were metered over the course of 2 hours 2000 parts of methanol.

Then, 1350 g of sodium m-nitrobenzenesulfonate were added, and immediately thereafter, 2400 parts of a 50% NaOH aqueous solution were added. Then, the mixture was refluxed for 4 hours, acidified with sulphuric acid to PH 3 to give 3675 g (of a theoretical value) of the compound of the formula XXVII after emptying out, filtration and washing, water and drying.

### EXAMPLE 2

2000 g of phosphoric acid 85.0% were placed at 20-25° C. in a 10000 ml “All In One Reactor”® of (Drais Mannheim Germany) followed by the slow addition of 2000 g of P₂O₅ under stirring and letting the temperature to go up to 80° C. Thereafter 1500 parts of 2,5-di-(4-toluidino)terephthalic acid (Formula V wherein R₂═R₃═4-CH₃) were added thereto under stirring and nitrogen flow. The mixture was now heated to 120° C. within 30 minutes and maintained at 120° C. for 30 minutes. Thereafter, the mixture was heated to 130° C. in 15 minutes and kept at 130° C. for one hour. The mixture was cooled to 70° C. followed by metering in of 3000 ml of isobutanol over a period of 2 hours with external cooling, and thereby allowing the temperature to reach the maximum reflux temperature of isobutanol. The mixture was stirred at reflux temperature for one hour, cooled to 70° C. and emptied into a stainless steel container. The resulting product was collected by filtration and reslurried in water containing sodium hydroxide to pH greater than 10. The slurry was heated at 90° to 95° C. for one hour, then again collected by filtration, washed until free of alkali, and dried to give 1316 g (97% theory) of the compound of the formula XXVII.

### EXAMPLE 13

2000 g of parts of the 6,13-dihydroquinacridone XXIV obtained in Example 4, 4000 ml of methanol and 757 g of sodium methylate were charged into the 10000 ml “All In One Reactor”® of (Drais Mannheim Germany) at 20-25° C. The mixture was heated with stirring to 50.degree. C. and stirred at 50° C. for 15 minutes to form a salt. Thereafter 20000 g of sodium m-nitrobenzenesulfonate was added, and the mixture was refluxed for 4 hours to give 1947 g (98.% of the theoretical yield) of the unsubustituted quinacridone of the formula XXVI

### EXAMPLE 14

700 g of the 6,13-dihydroquinacridone obtained in Example 4 and 2000 ml of methanol were charged to the 10000 ml “All In One Reactor”® of (Drais Mannheim Germany) at 20-25° C., and stirred. 840 g of a 50% NaOH aqueous solution was added, and the mixture was stirred at 30 degree C. for 30 minutes to form a salt. 910 g of 20% sulphuric acid was added dropwise to hydrolyse the salt, and the reaction mixture was heated to reflux and held at reflux for 1 hour. 700 g of sodium m-nitrobenzenesulfonate was added, and immediately thereafter, 3500 g of a 50% NaOH aqueous solution was added. Then, the mixture was refluxed for 4 hours to give 688 g (99.% of the theoretical yield) of the unsubustituted quinacridone of the formula XXVI.

### EXAMPLE 15

2000 g of parts of 2,5-di(p-toluidino)-3,6-dihydroterephthalic acid dimethyl ester of the formula XXIII obtained in Example 3, 4000 ml of methanol and 757 g of sodium methylate were charged into the 10000 ml “All In One Reactor”® of (Drais Mannheim Germany) at 20-25 ° C. The mixture was heated with stirring to 50 degree C. and stirred at 50° C. for 15 minutes to form a salt. Thereafter 1950 g of sodium m-nitrobenzenesulfonate was added, and the mixture was refluxed for 4 hours to give 1950 g (98% of the theoretical yield) of the 2,5-di(p-toluidino)-terephthalic acid dimethyl ester of the formula of the formula XXIX

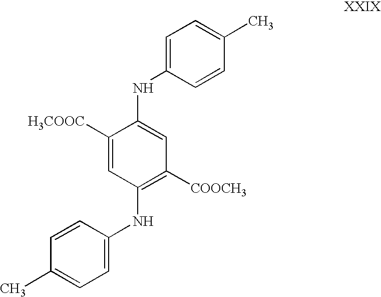

### EXAMPLE 17

2280 g of dimethyl succinnoylsuccinate [formula II, in which R₁═CH₃; 4-cyclohexanedione-2,5-di(carboxylic acid methyl ester)], 2226 g of p-toluidine, 2000 ml of isobutanol, and 40 g p-toluenesulphonic acid were placed at 20-25° C. in a 10000 ml “All In One Reactor”® of (Drais. Mannheim Germany). Under stirring and nitrogen flow the mixture was heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

Into the reactor were now metered 3000 parts of methanol. Then, 2500 g of sodium m-nitrobenzenesulfonate and, immediately thereafter, 1500 g of sodium methylate were added. The mixture was refluxed for 4 hours to give 3860 g (95.5% of the theoretical yield) of 2,5-di(p-toluidino)-terephthalic acid dimethyl ester of the formula XXIX after emptying out, filtration, washing with water and drying.

### EXAMPLE 18

1460 g dimethyl succinate (1.0 Mole) and 1800 g 30% sodium methylate solution (1.0 Mole) were placed at 20-25° C. in a 10000 ml “All In One Reactor”® of (Drais Mannheim Germany). Under stirring and nitrogen flow the mixture was heated to 130° C. within 250 minutes. From 50° C. onwards the reaction mixture became considerably thicker and was finally converted into a paste. From approx. 80° C. onwards a rapid formation of alcohol vapours was observed. The temperature was maintained at 125° C. for three hours, thereby allowing the rest of the alcohol to distil off. The reaction mass became crumbly and finally largely disintegrated into an almost semi-powdery material. The reaction mixture was cooled to 70° C. and 1060 g of p-toluidine were added thereto followed by the addition of 2000 g of isobutanol. Thereafter 490 g of sulphuric acid of 96% concentration and 30 g p-toluenesulfonic acid were slowly added thereto with external cooling to prevent the temperature to exceed 80° C. during the addition. Under stirring and nitrogen flow the mixture was now heated to 100° C. within 60 minutes. From 80° C. onwards the reaction mixture became considerably thicker and was finally converted into a paste. The temperature was maintained at 99° to 100° C. for three hours, thereby allowing the mixture of isobutanol and water formed to distil off. The reaction mass became crumbly and finally largely disintegrated into an almost semi-powdery material. The reaction mixture was heated to 120° C. in 30 minutes and kept at 120° C. for 30 minutes under vacuum of 50 mbar. The mixture was cooled to 50° C.

Into the reactor were now metered 3000 ml of methanol. Then, 1500 g of sodium m-nitrobenzenesulfonate and, immediately thereafter, 7500 g of sodium methylate were added. The mixture was refluxed for 4 hours to give 1750 g (86.6% of the theoretical yield) of 2,5-di(p-toluidino)-terephthalic acid dimethyl ester of the formula XXIX after emptying out, filtration, washing with water and drying.

### EXAMPLE 19

Example 18 was repeated except that the aniline was replaced with 1263 g of m-chloroaniline, to give 4605 g (99.3% of the theoretical yield) of 2,5-di(m-chloroanilino)-3,6-dihydroterephthalic acid dimethyl ester of the formula XXX. The purity thereof was 96.3%.

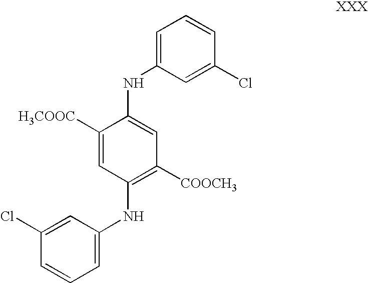

### EXAMPLE 20

2000 g of phosphoric acid 85.0% were placed at 20-25° C. in a 10000 ml “All In One Reactor”® of (Drais Mannheim Germany) followed by the slow addition of 2000 g of P₂O₅ under stirring and letting the temperature to go up to 80° C. Thereafter 1500 parts of 2,5-di-(3-chloroanilino)terephthalic acid dimethyleter XXX were added thereto under stirring and nitrogen flow. The mixture was now heated to 120° C. within 30 minutes and maintained at 120° C. for 30 minutes. Thereafter, the mixture was heated to 130° C. in 15 minutes and kept at 130° C. for one hour. The mixture was cooled to 70° C. followed by metering in of 3000 ml of isobutanol over a period of 2 hours with external cooling, and thereby allowing the temperature to reach the maximum reflux temperature of isobutanol. The mixture was stirred at reflux temperature for one hour, cooled to 70° C. and emptied into a stainless steel container. The resulting 2,9-dimethylquinacridone of he formula XV was collected by filtration and reslurried in water containing sodium hydroxide to pH greater than 10. The slurry was heated at 90° to 95° C. for one hour, then collected by filtration, washed until free of alkali, and dried to give 1316 g (97% theory) of a mixture of the compounds of the formulas XXXI, XXXII and XXXIII.

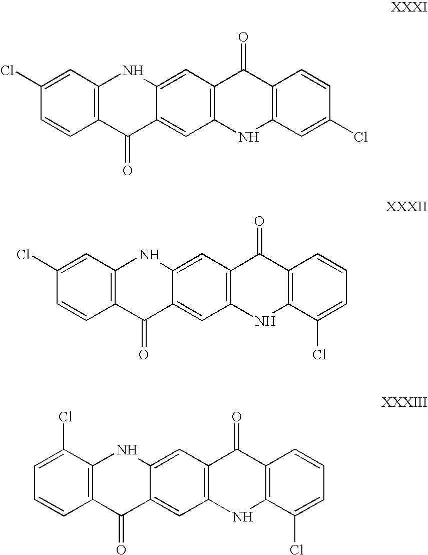

### EXAMPLE 21

4485 g (1.5 Mole) tetrachloro-o-cyanobenzoic acid methyl ester (Formula XV in which Z₁═Cl and S₁═CH₃) and 2400 g 30% sodium methylate solution (1.5 Mole) were placed at 20-25° C. in a 10000 ml “All In One Reactor”® of (Drais Mannheim Germany). Under stirring and nitrogen flow the mixture was heated to 40° C. within 20 minutes. The temperature was maintained at 40° C. for two hours. Thereafter a vacuum of 800 mbars was applied gradually increasing it to 50 mbars, thereby allowing the rest of the alcohol to distil off. The reaction mass became crumbly and finally largely disintegrated into an almost semi-powdery material.

The material was emptied into a steel drum affording approximately 5210 g of the product of the formula XXXIV. Approximately 100 g of the product were still contained in the reactor to be used in next batch.

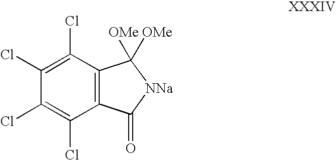

### EXAMPLE 22

2990 g (1.0 Mole) tetrachloro-o-cyanobenzoic acid methyl ester (Formula XV in which Z₁═Cl and S₁═CH₃) and 1800 g 30% sodium methylate solution (1.0 Mole) were placed at 20-25° C. in a 10000 ml “All In One Reactor”® of (Drais Mannheim Germany). Under stirring and nitrogen flow the mixture was heated to 40° C. within 20 minutes. The temperature was maintained at 40° C. for two hours. Thereafter 2500 ml of methanol were metered into the reactor followed by the addition of 1026 g (0.95 mole) of p-phenylenediamine. Under stirring and nitrogen flow the mixture was now heated to 65° C. within 60 minutes. The reaction mixture became considerably thicker and was finally converted into a paste. Thereafter a vacuum of 800 mbars was applied gradually increasing it to 50 mbars, thereby allowing the methanol to distil off. The reaction mass became crumbly and finally largely disintegrated into an almost semi-powdery material.

The material was emptied into a steel drum affording approximately 3210 g of the product of the formula XXXV. Approximately 100 g of the product were still contained in the reactor to be used in next batch.

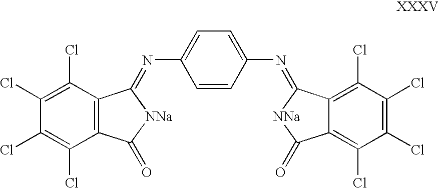

### EXAMPLE 23

2990 g (1.0 Mole) ) tetrachloro-o-cyanobenzoic acid methyl ester (Formula XV in which Z₁═Cl and S₁═CH₃) and 1800 g 30% sodium methylate solution (1.0 Mole) were placed at 20-25° C. in a 10000 ml “All In One Reactor”® of (Drais Mannheim Germany). Under stirring and nitrogen flow the mixture was heated to 40° C. within 20 minutes. The temperature was maintained at 40° C. for two hours. Thereafter 2500 ml of methanol were metered into the reactor followed by the addition of 1026 g (0.95 mole) of p-phenylenediamine. Under stirring and nitrogen flow the mixture was now heated to 65° C. within 60 minutes. The reaction mixture became considerably thicker and was finally converted into a paste. The mixture was acidified with 600 g of acetic acid. Thereafter a vacuum of 800 mbar was applied gradually further reducing it to 50mbars and, thereby allowing the methanol to distil off. The reaction mass became crumbly and finally largely disintegrated into an almost semi-powdery material.

The material was emptied into a steel drum affording approximately 3890 g of the product of the formula XXXVI. Approximately 100 g of the product were still contained in the reactor to be used in next batch.

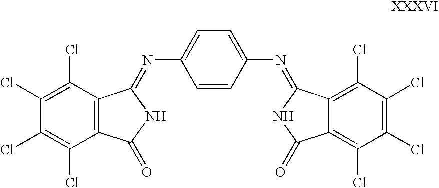

### EXAMPLE 24

1000 g of the material obtained in Example 22 were reslurried in 10000 ml water at 200 to 25° C. containing 200 ml acetic acid. The slurry was heated at 90° to 95° C. for one hour, then collected by filtration, washed until free of acid and salts, and dried to give 850 g the compound of the formula XXXVI.

### EXAMPLE 25

1000 g of the material obtained in Example 23 were reslurried in 10000 ml water at 20° to 25° C. The slurry was heated at 90 to 95° C. for one hour, then collected by filtration, washed until free of acid, and dried to give 790 g the compound of the formula XXXVI

### EXAMPLE 26

1000 g of the material obtained in Example 22 were reslurried in 10000 ml methanol at 20to 25° C. containing 180 ml acetic acid. The slurry was heated at 650 for four hours, then collected by filtration, washed until free of acid and salts, and dried to give 850 g the compound of the formula XXXVI.

### EXAMPLE 27

2990 g (1.0 Mole) tetrachloro-o-cyanobenzoic acid methyl ester (Formula XV in which Z₁═Cl and S₁═CH₃) and 1800 g 30% sodium methylate solution (1.0 Mole) were placed at 20-25° C. in a 10000 ml “All In One Reactor”® of (Drais Mannheim Germany). Under stirring and nitrogen flow the mixture was heated to 40° C. within 20 minutes. The temperature was maintained at 40° C. for two hours. Thereafter 2500 ml of o-dichlorobenzene were metered into the reactor followed by the addition of 1160 g (0.95 mole) of 2,6-diaminotoluene. Under stirring and nitrogen flow the mixture was now heated to 100° C. within 60 minutes and stirred at 100° C. for 4 hours, whilst methanol distils off . Thereafter a vacuum of 800 mbar was applied gradually further reducing it to 50 mbars and, thereby allowing the o-dichlorobenzene to distil off. The reaction mass became crumbly and finally largely disintegrated into an almost semi-powdery material.

The material was emptied into a steel drum affording approximately 3110 g of the product of the formula XXXVII. Approximately 100 g of the product were still contained in the reactor to be used in the next experiment.

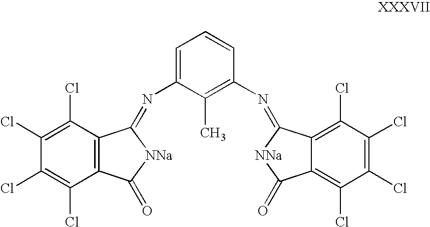

### EXAMPLE 28

2990 g (1.0 Mole) tetrachloro-o-cyanobenzoic acid methyl ester (Formula XV in which Z₁═Cl and S₁═CH₃) and 1800 g 30% sodium methylate solution (1.0 Mole) were placed at 20-25° C. in a 10000 ml “All In One Reactor”® of (Drais Mannheim Germany). Under stirring and nitrogen flow the mixture was heated to 40° C. within 20 minutes. The temperature was maintained at 40° C. for two hours. Thereafter 2500 ml of o-dichlorobenzene were metered into the reactor followed by the addition of 1160 g (0.95 mole) of 2,6-diaminotoluene. Under stirring and nitrogen flow the mixture was now heated to 100° C. within 60 minutes and stirred at 100° C. for 4 hours, whilst methanol distils off. The reaction mixture became considerably thicker and was finally converted into a paste. The mixture was acidified with 600 g of acetic acid. Thereafter a vacuum of 800 mbar was applied gradually further reducing it to 50 mbars and, thereby allowing the o-dichlorobenzene to distil off. The reaction mass became crumbly and finally largely disintegrated into an almost semi-powdery material.

The material was emptied into a steel drum affording approximately 4120 g of the product of the formula XXXVIII. Approximately 100 g of the product were still contained in the reactor to be used in the next experiment.

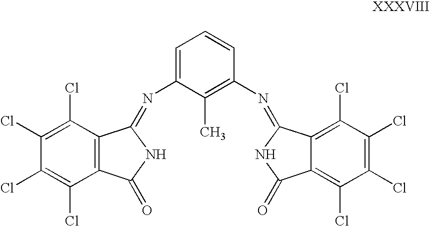

### EXAMPLE 29

1000 g of the material of the formula XXXXVII obtained in Example 27 were reslurried in 10000 ml water at 20° to 25° C. containing 180 ml acetic acid. The slurry was heated at 90° to 95° C. for one hour, then collected by filtration, washed until free of acid and salts, and dried to give 850 g the compound of the formula XXXVIII.

### EXAMPLE 30

1000 g of the material obtained in Example 28 were reslurried in 10000 ml water at 20° to 25° C. The slurry was heated at 90 to 95° C. for four hours, then collected by filtration, washed until free of acid, and dried to give 750 g the compound of the formula XXXVIII.

### EXAMPLE 31

1000 g of the material of the formula XXXXVII obtained in Example 27 were reslurried in 10000 ml methanol at 20° to 25° C. containing 180 ml acetic acid. The slurry was heated at 65’ for four hours, then collected by filtration, washed until free of acid and salts, and dried to give 850 g the compound of the formula XXXVIII.

### EXAMPLE 32

3840 g of phthalodinitrile (3.0 Mole) and 50 g 30 % sodium methylate solution and 5000 ml of methanol were placed at 30° C. in a 10000 ml “All In One Reactor”® of (Drais Mannheim Germany). Thereafter 600 g of gaseous ammonia were slowly introduced into it over a period of 4 hours thereby maintaining the temperature at 30° C. Thereafter a vacuum of 800 mbars was applied gradually increasing it to 50 mbars, thereby allowing the methanol to distil off. The reaction mass became crumbly and finally largely disintegrated into an almost semi-powdery material.

The material was emptied into a steel drum affording approximately 4250 g of the product of the formula XXXXIX. Approximately 100 g of the product were still contained in the reactor to be used in next batch.

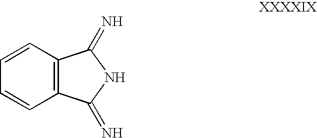

### EXAMPLE 33

1280 g of phthalodinitrile (1 Mole) and 15 g 30% sodium methylate solution and 3000 ml of methanol were placed at 30° C. in a 10000 ml “All In One Reactor”® of (Drais Mannheim Germany). Thereafter 200 g of gaseous ammonia were slowly introduced into it over a period of 4 hours thereby maintaining the temperature at 30° C. Thereafter a vacuum of 800 mbars was applied gradually increasing it to 50 mbars, thereby allowing the methanol to distil off. The reaction mass became crumbly and finally largely disintegrated into an almost semi-powdery material.

Into the reactor were now metered 4000 ml of methanol at 20-25° C. followed by the addition of 2816 g of barbituric acid and 350 ml of glacial acetic acid. Under stirring and nitrogen flow the mixture was now heated to 65° C. within 60 minutes and maintained at the reflux temperature for 4 hours. Thereafter a vacuum of 800 mbar was applied gradually further reducing it to 50 mbars and, thereby allowing the methanol and excess acetic acid to distil off. The reaction mass became crumbly and finally largely disintegrated into an almost semi-powdery material. The material was emptied into a steel drum affording approximately 3500 g of the product of the formula XL. Approximately 100 g of the product were still contained in the reactor to be used in next batch.

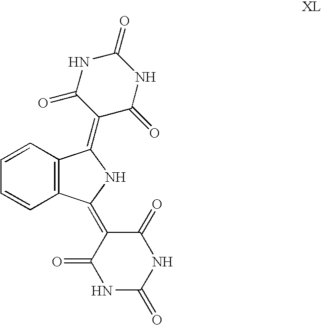

### EXAMPLE 34

1000 g of the material obtained in Example 33 were reslurried in 10000 ml water at 20° to 25° C. The slurry was heated at 90° to 95° C. for five hours, then collected by filtration, washed until free of acid, and dried to give 820 g the compound of the formula XL

### EXAMPLE 35

1450 g (1.0 Mole) of diiminoisoindoline of the formula XXXXIX obtained as described in Example 32, 2816 g of barbituric acid and 4000 ml of methanol and 350 ml of glacial acetic acid were placed at 30° C. in a 10000 ml “All In One Reactor”® of (Drais Mannheim Germany). Under stirring and nitrogen flow the mixture was now heated to 65° C. within 60 minutes and maintained at the reflux temperature for 4 hours. Thereafter a vacuum of 800 mbar was applied gradually further reducing it to 50 mbars and, thereby allowing the methanol and excess acetic acid distil off. The reaction mass became crumbly and finally largely disintegrated into an almost semi-powdery material. The material was emptied into a steel drum affording approximately 3550 g of the product of the formula XL. Approximately 100 g of the product were still contained in the reactor to be used in next batch.

### EXAMPLE 36

1000 g of the material obtained in Example 33 were reslurried in 10000 ml water at 20° to 25° C. The slurry was heated at 90° to 95° C. for five hours, then collected by filtration, washed until free of acid, and dried to give 820 g of the compound of the formula XL

### EXAMPLE 37

A mixture of 474 g 8-aminoquinaldine, 1888 g tetrachlorophthalic anhydride, 120 g anhydrous zinc chloride and 3000 ml of 1-chloronaphthelene were placed at 20-25° C. in a 10000 ml “All In One Reactor”® of (Drais Mannheim Germany). Under stirring and nitrogen flow the mixture was heated to 220° C. within 60 minutes and allowed to react for 3 hours at 220° C., steam formed being allowed to escape during the reaction. Thereafter the mixture was cooled to 180° C. and 3000 parts by volume of N-methylpyrrolidone were added thereto. The mixture was stirred at 200° C. for one hour. The product was cooled to 150° C., discharged into a container and separated by filtration. The resulting yellow product was thoroughly washed with 1,000 parts of N-methylpyrrolidone and then with methanol followed by water, and dried to afford 1880 g of a yellow pigment of the formula XLI.

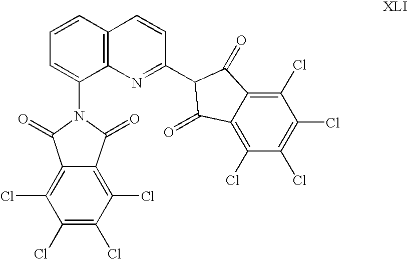

1. A process for the manufacture of organic pigments selected from the group of quinacridone pigments, isoindoline pigments, isoindolinone pigments, quinophthalone pigments and of the precursors thereof, wherein the reactants for the formation of said materials are introduced into a reactor and the reaction mixture submitted to enhanced driving power as expressed by a Froude number >1, the reaction mixture being caused to react at elevated temperature.

2. A process according to claim 1, wherein the said reactor is an “All In One Reactor”® (Draiswerke GmbH, Germany), a kneader like the TurbuKneader® of the same company, a paddle dryer like the Turbudry® of the same company or a related system.

3. A process according to claim 1 for the preparation of a compound of the formula VI wherein each R₂ and R₃ independently of the other is a hydrogen, a chlorine, a methyl, a methoxy or an N-alkylsulfonamide group, and/or a mixture thereof.

4. A process according to claim 1 for the preparation of a compound of the formula V wherein each R₂ and R₃ independently of the other is a hydrogen, a chlorine, a methyl, a methoxy or an N-alkylsulfonamide group, and/or a mixture thereof.

5. A process according to claim 1 for the preparation of a compound of the formula IV wherein each R₂ and R₃ independently of the other is a hydrogen, a chlorine, a methyl, a methoxy or an N-alkylsulfonamide group, and/or a mixture thereof.

6. A process according to claim 1 for the preparation of a compound of the formula III wherein each R₂ and R₃ independently of the other is a hydrogen, a chlorine, a methyl, a methoxy or an N-alkylsulfonamide group, and/or a mixture thereof.

7. A process according to claim 1 for the preparation of a compound of the formula II wherein each R₁ is a C₁ to C₈ alkyl radical.

8. A process according to claim 1 for the preparation of a compound of the formula IX

9. A process according to claim 1 for the preparation of a compound of the formula XV

10. A process according to claim 1 for the preparation of a compound of the formula XVII

11. A process according to claim 1 for the preparation of a compound of the formula XVIII.

12. A process according to claim 1 for the preparation of the compound of the formula XXXXIX

13. A process according to claim 1, wherein the reaction mixture is treated at a temperature between 60° C. and 350° C.

14. A pigment as prepared by the process according to claim 1.
